(19) United States
(12) Patent Application Publication
(10) Pub. No.: US 2019/0270397 A1
(43) Pub. Date: Sep. 5, 2019

(54) Molded Lightweight Layered Floor Liner Construction

(71) Applicant: Corinthian Textile Solutions, Inc., Portland, OR (US)

(72) Inventors: James David Owens, Chattanooga, TN (US); Daniel Michael Gaines, Cartersville, GA (US); John M. Stanesic, Dacula, GA (US)

(21) Appl. No.: 16/255,421

(22) Filed: Jan. 23, 2019

Related U.S. Application Data
(60) Provisional application No. 62/637,811, filed on Mar. 2, 2018.

(51) Int. Cl. B60N 3/04; B32B 5/12; B32B 5/02; B32B 5/26; D06N 7/00; B60R 13/01; B62D 65/02

(52) U.S. Cl. CPC B60N 3/048; B32B 2471/02; B32B 5/022; B32B 5/26; D06N 7/0071; B60N 3/044; B60N 3/046; B60R 13/01; B62D 65/02; B60R 13/013; B32B 2605/00; B32B 2255/26; B32B 2262/0284; B32B 2262/0261; B32B 2262/0253; B32B 2255/02; B32B 5/12

(57) ABSTRACT

A molded lightweight layered floor liner construction includes a top layer with an exposed carpeted hobnail surface, a middle layer including a moldable thermoplastic coating on the back of the top layer, and a bottom layer having a downwardly exposed surface characterized by singed non-woven fabric. The floor liner is lightweight, molded by known molding techniques, impervious to water, liquids, mud, and debris, and resistant to sliding and bunching up on the factory carpeted surfaces of a vehicle. The exposed hobnail surface interacts very well with mechanical fastening systems such as the hooks of a hook-and-loop fastener system. Thus, accessories such as cargo organizers can be placed on the exposed surface of the floor liner, where they stick firmly until pulled away, removed, and repositioned.

### REFERENCE TO RELATED APPLICATION

Priority is hereby claimed to the filing date of U.S. provisional patent application 62/637,811 entitled Molded Lightweight Layered Floor Liner Construction filed on Mar. 2, 2018, the content of which is hereby incorporated by reference.

### TECHNICAL FIELD

This disclosure relates generally to automotive floor coverings and more specifically to molded floor liners for floorboards, trunks, and cargo areas of vehicles.

### BACKGROUND

Molded floor liners for the floorboards, trunks, and cargo areas of vehicles are common. For luxury vehicles, floor liners generally have a carpeted top surface. Such liners may have a fabric or rubber-like bottom surface made from an appropriate polymer such as, for example, Thermoplastic Olefin (TPO), Thermoplastic Elastomer (TPE), or Ethylene Vinyl Acetate (EVA) with or without fillers. While attractive, traditional prior art floor liners exhibit various problems and shortcoming inherent in their respective designs. For example, because of the rubberized polymer layers beneath the top carpeted layer, such floor liners, especially where fillers are used, tend to be heavy and the cost of manufacturing is relatively high. Molding these floor liners into a specific shape for a specific vehicle also can be a problem. Further, polymer layers with fillers such as calcium carbonate can absorb moisture that can lead to mold and mildew problems.

Prior art floor liners with cut pile carpeted top surfaces do not interact ideally with items having hook-type fasteners intended to stick to these surfaces, such as cargo organizers. Further, many prior art floor liners tend to slip or slide on the surfaces of floor boards, trunks, and cargo areas, eventually moving out of position, riding up the sides of these areas, or bunching up. Efforts to address sliding have included downwardly projecting nibs molded into the bottom layers of floor liners and smooth flat bottom surfaces. These have not proven completely successful and movement of floor liners with such features can still occur.

A need exists for a floor liner construction that may have a carpeted top surface that interacts well with hook-type fasteners for securing in place items such as cargo organizers, that is lightweight and easily moldable from flat blanks, and that successfully resists sliding and bunching up on carpeted surfaces of floorboards, trunks, and cargo areas. It is to the provision of such a floor liner construction that the present invention is primarily directed.

### SUMMARY

Briefly described, a lightweight layered floor liner has, in in one embodiment, a top exposed layer of a non-woven hobnail carpet construction. The top layer is configured so that an item with a hook-type fastener such as a cargo organizer adheres securely to the top layer when placed thereon, but can be pulled away and removed as needed. A middle layer is applied to the back of the top layer and in preferred embodiments comprises a coating of low density polyethylene (LDPE) or other appropriate moldable thermoplastic material. This provides a bond, allows the top layer and the backing layer to be molded together to fit a particular area of a vehicle, and forms a barrier to help keep underlying carpet dry and clean. A bottom layer underlies the middle layer and may be made of a non-woven polymer material that is singed on its exposed face. The singed surface grips an underlying factory carpeted surface and prevents the floor liner from sliding and becoming displaced or bunched up on the surface.

The floor liner of this invention is significantly lighter in weight than traditional floor liners. Further, it can be made in flat blanks that subsequently can be molded to a specific shape to fit a designated area. The hobnail top surface interacts well with hook-type fasteners to secure objects with such fasteners releasably to the top surface. The singed bottom layer grips and does not slip on factory carpeted surfaces. These and other aspect, features, and advantages of the invention will become more apparent upon review of the detailed description presented below made in conjunction with the attached drawing figures, which are briefly described as follows.

### BRIEF DESCRIPTION OF THE DRAWINGS

FIG. 1 is a perspective view of a molded floor liner in position on the floorboard of a vehicle.

FIG. 2 is a perspective view of a floor liner blank of the present invention prior to molding and showing corners raised to reveal the various layers of the floor liner construction.

FIG. 3 is a cross-sectional view of a floor liner illustrating the present invention in one preferred embodiment.

### DETAILED DESCRIPTION

The description and claims below refer to the invention as a “floor liner” for clarity of discussion. It will be understood to the skilled artisan, however, that the invention is not limited by this selected term but includes floor mats, floor coverings, and any protective cover intended to cover an area in a vehicle. Indeed, the invention may be applied in areas outside of vehicles such as, for instance, floor mats and coverings for motor homes, trailers, and trucks. So, the selected term “floor liner” as used herein should be construed broadly and not in a limiting way.

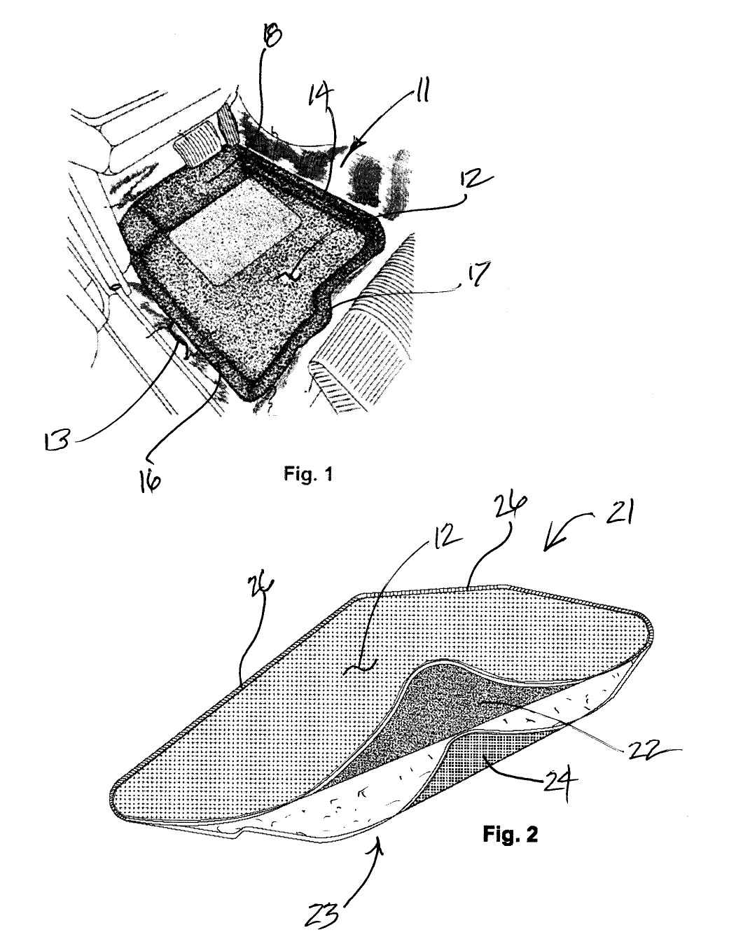

Reference will now be made in more detail to the drawing figures, wherein like reference numerals indicate like parts throughout the several views. FIG. 1 depicts a carpeted floor liner of the invention located in this example in the front floor board of a vehicle on the driver's side. The floor liner 11 has a carpeted upper surface 12 preferably in the form of a hobnail pattern, which exhibits a large number of randomly oriented small loops of fibers. The floor liner 12 is molded by known techniques so that it has upturned side edges 14 and 16, an upturned back edge 17, and an upturned front edge 18. The molded shape of the floor liner can be configured to fit the contours of a floorboard, trunk, or cargo area or alternatively may be decorative or form boundaries for containment of water, other liquids, mud, and debris.

The floor liner 12 sits upon the factory carpeted surface 13 of the vehicle as shown. As described in more detail below, the bottom layer of the floor liner that contacts the factory carpet is made of a fibrous fabric material such as a non-woven polyethylene terephthalate (PET), nylon, polypropylene (PP), or other appropriate synthetic fibrous material. This fabric material preferably is singed by having been exposed to flame, heated rollers, a flow of heated air, or other appropriate heat source. The singing process partially melts the ends of fibers in the fabric causing them to take on a bulbous or mushroom shape. When the floor liner is placed on a factory carpeted surface of a vehicle, these melt-modified ends tend to interact with the fibers of the factory carpet in a manner similar to the way hooks of a hook-and-loop fastener interact with loops of the fastener. This interaction, in turn, causes the floor liner to “stick” to the factory carpet so that is does not slide around or become displaced or bunched up in use. However, the liner can be easily removed if desired or necessary.

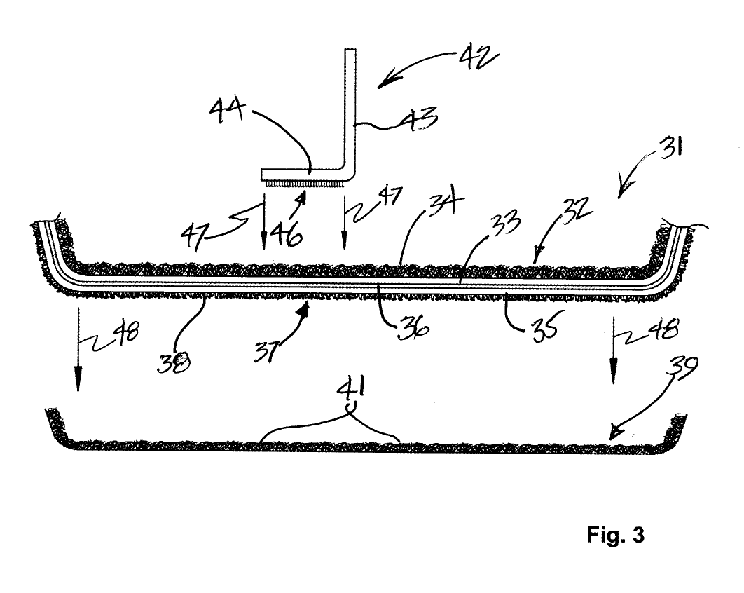

FIG. 2 illustrates a flat floor liner blank of the present invention prior to being molded to a desired shape for placement in a vehicle. The blank comprises a top layer 12 of carpet material with an exposed face that preferably exhibits large numbers of small randomly oriented loops of yarn in its pattern. In this regard, it has been found that carpet with a backing and a non-woven hobnail pattern on its exposed surface is preferred. The non-woven exposed surface preferably is made from a blend of PET and a low melt polyethylene formed into fibers and having a selected face weight and denier. This has been found to result in a surface that is extremely durable and that exhibits excellent hook-and-loop cycling characteristics when used with items such as cargo organizers, as discussed in detail below.

While a hobnail pattern or other patterns that exhibit large numbers of exposed loops of fibers are preferable for the top layer, the invention is not limited to floor liners with such structure. The top layer may, for instance, exhibit a cut pile construction or a tufted construction. While such alternative constructions of the top layer may not be ideal for interacting with hook-type fasteners, a floor liner with such a top layer still exhibits other desirable characteristics of the invention such as moldability. They are therefore included within the scope of the present invention.

A middle layer 22 is applied to the back of the top layer 12. This middle layer preferably is a coating of LDPE that may be sprayed, rolled, extruded, sintered, applied as a sheet or film, or otherwise bonded to the back of the top layer. The middle layer has several benefits including providing a bond on the back of the top layer, allowing for moldability of the completed blank 21 into desired configurations, and acting as a barrier to prevent water and other contaminants from leaking through to underlying factory carpets. In addition, a coating of LDPE or other appropriate material as the middle layer is far lighter than synthetic rubber layers of the prior art and contributes to a much lighter floor liner product.

A bottom layer of the blank 21 underlies the top and middle layers. The layers may be bonded together by surging 26 around the edges of the layers. The bottom layer also may be at least partially bonded to the LDPE coating that forms the middle layer. The bottom layer preferably is formed of a non-woven PET material with an exposed surface 24 that is singed by having been exposed to a flame, heated roller, a hot air stream, or another source of heat during manufacturing. As mentioned briefly above, the singing process partially melts the ends of PET fibers in the non-woven fabric forming tiny bulbs or mushroom-shapes on the ends of the fibers.

It has been found that these bulbous ends of the singed fibers interact with an underlying factory carpeted surface in much the way that the hooks of a hook-and-loop fastener interact with the loops of the fastener. More specifically, the bulbous ends of the singed fibers become entangled and locked in the fibers of a carpeted surface when the floor liner is placed on the surface. This causes the floor liner to “stick” to the carpeted surface similar to the way hook-and-loop fasteners stick together. As a result, floor liners made according to this invention do not tend to slide around and become displaced or bunched up when they are placed in a floor, trunk, or cargo area of a vehicle. In fact, this system functions much more efficiently than prior art slide resisting systems such as downwardly projecting nibs on the bottom surface of a floor mat or simple smooth bottom surfaces.

Of course, the ends of the fibers can be misshaped in other ways too, such as, for instance, being bent, roughly cut, formed with barbs, or otherwise malformed so that they have a gripping quality. All such misshapen fiber ends should be considered to be within the scope of the present invention.

FIG. 3 is a cross-sectional view of a floor liner that embodies principles of the invention. The floor liner 31 is molded so that it fits in an area 39 of a vehicle such as a floor board, trunk, or cargo area. The area 39 is provided with an exposed factory carpeted surface 41, as is familiar to those of skill in the art. The floor liner 31 has a top layer 32 that comprises a backing 33 from which tufts of yarn 34 project upwardly to an exposed surface. As mentioned, the tufts preferably are configured in what is known as a hobnail pattern, which is known to exhibit large numbers of randomly oriented small loops of fiber. It will be understood, however, that a hobnail pattern is not a limitation of the invention and other carpet patterns may be substituted with equivalent or similar results. It should be noted that in FIG. 3, thicknesses of the various layers such as the backing layer 33 and the bottom layer 37 are exaggerated so that they are more visible. In reality, these layers may be substantially thinner than illustrated.

The middle layer 36 of the floor liner 31 comprises a coating of material that is waterproof, moldable, and forms a bond. The preferred material for this middle layer is an LDPE that can be sprayed, rolled, sintered, extruded onto, or otherwise applied to the backing 33 of the top layer. However, other materials such as, for instance, LDPE, TPO, TPE, EBA, or any other moldable thermoplastic material with appropriate properties might be used. Once cured, the middle layer stiffens the top layer and renders it moldable into a desired configuration by known molding processes.

The bottom layer 37 of the floor liner 31 comprises a material that is singed in such a way that the fibers of the material partially melt and form bulbous or mushroom shapes on the ends of the fibers. These shapes cure and become permanent features after heating. Preferably, the material of the bottom layer is a non-woven PET material that may or may not be attached to a backing such as backing 35 in FIG. 3. Free ends of fibers of such PET material are known to melt and form bulbs or mushroom shapes on the fibers when singed by exposure to heat. The singed fibers are illustrated at 38 in FIG. 3 and project downwardly from the bottom layer 37 of the floor liner to an exposed surface with singed fiber ends.

When the floor liner is lowered onto the factory carpeted surface 39 of a vehicle, be it a floor board, trunk, cargo area, or other area, the bulbous ends of the singed fibers become mechanically entangled in the fibers of the factory carpeting thereby removably sticking the floor liner to the carpeted surface. FIG. 3 also illustrates an accessory 42 such as, for instance, a cargo organizer that, in this example, has a horizontal base 44 and a vertical wall 43. A plurality of the hook portions of a hook-and-loop fastening system project downwardly from the bottom of the horizontal base 44.

When the accessory 42 is lowered onto the exposed surface of the floor liner as indicated by arrows 47, the hooks of the accessory become mechanically entangled with the looped fibers of the hobnail surface thereby sticking the accessory firmly to the floor liner. When desired, however, the accessory can be ripped away from the floor in the fashion familiar to users of hook-and-loop fasteners and repositioned as desired. In this regard, the hobnail pattern of the exposed surface on the floor liner has proven to be extremely tolerant of the placement and removal of hook-and-loop accessories so that degradation of the function after many uses is virtually eliminated. Carpeted surfaces that are less interactive with hook-type fasteners such as cut pile and tufted surfaces also are within the scope of the invention.

The invention has been described herein in terms of preferred embodiments and methodologies considered by the inventors to represent the best mode of carrying out the invention. It will be understood, however, that a wide gamut of additions, deletions, and modification, both subtle and gross, might well be made to the illustrated embodiment without departing from the spirit and scope of the invention embodied within the preferred embodiments.

What is claimed is:

1. A molded lightweight layered floor liner comprising:
a top layer having a backing and an exposed upper surface;
a middle layer bonded to a back surface of the top layer, the middle layer made of a lightweight material that is moldable to form a desired shape of the floor liner; and
a bottom layer underlying the middle layer, the bottom layer having a downwardly exposed surface comprising a fabric material with exposed fibers having misshaped ends;
the misshaped ends of fibers of the bottom layer interacting with the carpeted surface of a floor of a vehicle to hold the floor liner in place on the carpeted surface while allowing the floor liner to be removed if desired.

2. A molded lightweight layered floor liner as claimed in claim 1 wherein the top layer comprises carpet.

3. A molded lightweight layered floor liner as claimed in claim 2 wherein the carpet comprises looped fibers.

4. A molded lightweight layered floor liner as claimed in claim 3 wherein the looped fibers are arranged in a hobnail pattern.

5. A molded lightweight layered floor liner as claimed in claim 2 wherein the carpet comprises a looped-pile carpet.

6. A molded lightweight layered floor liner as claimed in claim 2 wherein the carpet comprises a cut-pile carpet.

7. A molded lightweight layered floor liner as claimed in claim 1 wherein the middle layer comprises a coating of material that is waterproof, moldable, and forms a bond with the top layer.

8. A molded lightweight layered floor liner as claimed in claim 7 wherein the material of the middle layer comprises low density polyethylene (LDPE).

9. A molded lightweight layered floor liner as claimed in claim 8 wherein the LDPE is sprayed, rolled, sintered, extruded onto, or otherwise applied to the backing of the top layer.

10. A molded lightweight layered floor liner as claimed in claim 1 wherein the bottom layer comprises a non-woven fabric material.

11. A molded lightweight layered floor liner as claimed in claim 10 wherein the non-woven fabric material comprises polyethylene terephthalate (PET), nylon, or polypropylene (PP).

12. A molded lightweight layered floor liner as claimed in claim 1 wherein the misshaped exposed ends of the fibers of the bottom layer are bulbous or mushroom-shaped.

13. A molded lightweight layered floor liner as claimed in claim 12 wherein the fabric of the bottom layer is sintered to form the bulbous or mushroom-shaped ends.

14. A method of securing a floor liner releasably in place on a carpeted surface comprising applying a layer of sintered fabric material to the bottom of the floor liner, the fibers of the sintered fabric interacting with the carpeted surface to secure the floor line in place on the carpeted surface while allowing the floor liner to be removed if desired.

15. The method of claim 14 wherein the applying step comprises applying a layer of sintered non-woven fabric to the bottom of the floor liner.

16. The method of claim 15 wherein the applying step comprises applying a layer of sintered non-woven polyethylene terephthalate (PET), nylon, or polypropylene (PP) fabric to the bottom of the floor liner.

17. A floor liner comprising a top layer having an upwardly exposed carpeted surface, a bottom layer having a downwardly exposed surface comprising a fabric material with the ends of fibers of the fabric being misshaped to provide a gripping quality to the exposed surface, and a middle layer between the top layer and the bottom layer, the middle layer being impervious to moisture and being heat moldable to allow the floor liner to be molded into a desired shape.

18. The floor liner of claim 17 wherein the fabric material is a non-woven fabric material.

19. The floor liner of claim 18 wherein the non-woven fabric material comprises a non-woven polyethylene terephthalate (PET), nylon, or polypropylene (PP) fabric material.

20. The floor liner of claim 19 wherein the fabric material is sintered to produce misshapen ends on the fibers of the fabric.

21. The floor liner of claim 20 wherein the misshapen ends comprise bulbous or mushroom-shaped ends.

22. The floor liner of claim 17 wherein the middle layer comprises low density polyethylene (LDPE).
